(19) United States
(12) Patent Application Publication
(10) Pub. No.: US 2014/0164051 A1
(43) Pub. Date: Jun. 12, 2014

(54) Recommending a Next Step to Take in a Case

(71) Applicants: Hamid Reza Motahari Nezhad, Los Altos, CA (US); Claudio Bartolini, Palo Alto, CA (US)

(72) Inventors: Hamid Reza Motahari Nezhad, Los Altos, CA (US); Claudio Bartolini, Palo Alto, CA (US)

(21) Appl. No.: 14/131,536

(22) PCT Filed: Aug. 25, 2011
(86) PCT No.: PCT/US2011/049051

§ 371 Date: Jan. 8, 2014

(51) Int. Cl. G06Q 10/06

(52) U.S. Cl. CPC G06Q 10/0633
USPC 705/7.27

(57) ABSTRACT

A flow model of an activity flow that is based on cases is provided. The flow model is annotated with information from the cases. A matching step in the activity flow that matches a given step of a particular case is identified, and a next step is recommended based on the matching step in the activity flow of the flow model.

### BACKGROUND

An enterprise, such as a business, educational organization, or government agency, typically includes an information technology (IT) infrastructure that has user electronic devices, server computers, storage systems, and/or other types of electronic devices. Incidents can occur in the IT infrastructure, and such incidents are usually addressed by IT management personnel. In a relatively large or complex IT infrastructure, IT incident management can be challenging.

### BRIEF DESCRIPTION OF THE DRAWINGS

Some embodiments are described with respect to the following figures:

FIG. 1 is a block diagram of an example arrangement that includes an information technology (IT) support management system, in accordance with some implementations;

FIG. 2 is a flow diagram of a process of IT incident management according to some implementations;

FIG. 3 is a schematic diagram of components of an IT support case, according to some examples;

FIG. 4 is a schematic diagram of an arrangement for IT support management according to further implementations; and

FIG. 5 is a schematic diagram of an example flow model according to some implementations.

### DETAILED DESCRIPTION

An information technology (IT) infrastructure includes various devices that are able to cooperate with each other to perform target tasks or to allow users to perform desired tasks. Examples of the devices include user electronic devices, server computers, storage systems, communications networks and associated equipment, and so forth. Examples of user electronic devices include desktop computers, notebook computers, tablet computers, personal digital assistants (PDAs), smartphones, and so forth. Examples of server computers include application servers (that provide applications that can be executed by user electronic devices), storage servers (that manage storage systems), database servers (that manage database systems), and so forth. Communications networks can include local area networks (LANs), wide area networks (WANs), wireless networks, and so forth.

In an IT infrastructure, various incidents can occur. For example, a device or a communications network can experience a fault or failure. As other examples, applications or operating systems running on various devices may crash or otherwise not function properly. In a relatively large IT infrastructure, there can be large numbers of different types of incidents, and it can be challenging for IT management personnel to address such IT incidents, even with automated IT management tools.

An IT incident can be represented by an IT support case, where an “IT support case” refers to any representation (such as in the form of a record or other type of representation) that contains information regarding the IT incident.

An IT support management process (for handling an IT incident) can involve multiple IT personnel and can also involve collaboration among IT personnel. Collaboration can include communications between IT personnel, such as electronic mail conversations, text-based conversations, social networking communications, or other forms of interactions. Collaboration between IT personnel can be recorded for later access.

The ability to apply collaborative techniques to manage IT support cases allows for flexible conversations among participants, including IT support personnel, and possibly end users, to achieve case resolution and to help address the issue of information loss in handoff between collaborating personnel.

A collaboration-based IT support management process for processing an IT support case can include a flow of activities taken to process the IT support case, where the flow of activities includes a collection of steps that can be taken by one or multiple IT personnel. A “step” represents an individual activity in the activity flow. Information regarding an activity flow and the corresponding steps of the activity flow can be provided in an IT support case.

An issue that IT personnel may face in performing collaboration-based IT support management processes is that the IT personnel may have to repeatedly define the same or similar activity flows for similar cases. If the repeated definition of similar cases is performed manually, then that could be quite labor intensive. IT support personnel may benefit from reusing the wealth of knowledge that is present in an IT support organization about the best sequence of activities to follow to resolve a given IT support case, based on learning from past similar case resolutions.

In accordance with some implementations, techniques or mechanisms are provided to guide resolution of a new IT support case, by providing automated recommendation of the best next step(s), and possibly expert(s), to use for resolving the new IT support case, based on the knowledge of past similar cases. IT support personnel can receive a relatively large number of IT support cases per day (such as in the form of incoming calls, incoming electronic mail, etc.), and many of such IT support cases may be similar to cases that have occurred in the past. Even if some percentage of the new IT support cases benefit from automatic guidance on activities that lead to quicker and effective case resolution, efficiency gains can be achieved by an IT support management system.

Although reference is made to IT support cases in the present discussion, it is noted that techniques or mechanisms according to some implementations can also be applied to other types of cases. More generally, a “case” refers to any representation of an issue that is to be addressed by an enterprise, which can include a business, an educational organization, a government agency, an individual, and so forth.

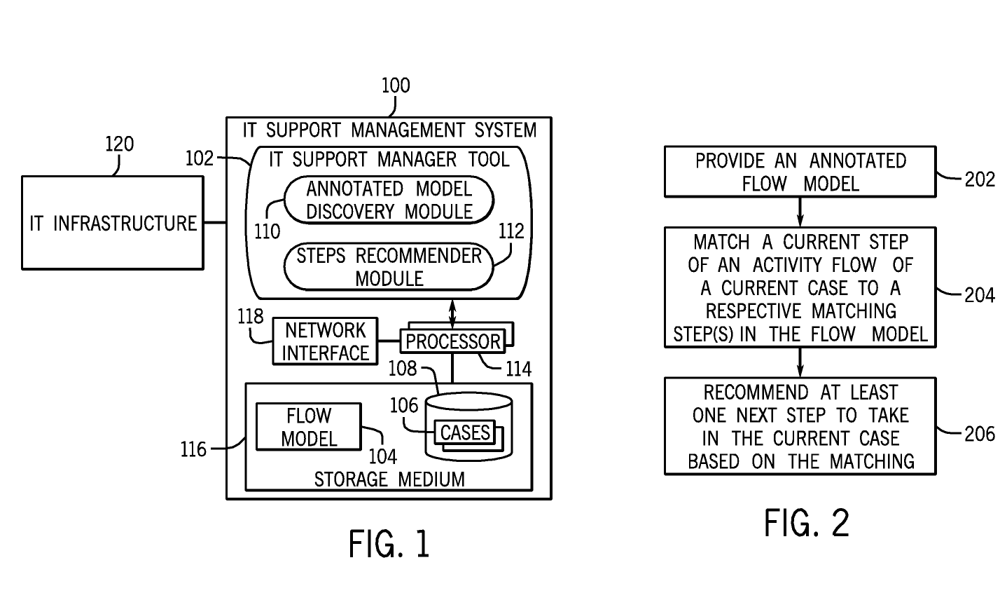

As shown in FIG. 1, in accordance with some implementations, an IT support management system 100 includes an IT support manager tool 102 that is provided to recommend a best next step (or steps) for a current IT support case. The IT support manager tool 102 builds a flow model (e.g. 104 in FIG. 1) of activity flows of past IT support cases (depicted as cases 106 in a repository 108 in FIG. 1) that have been annotated with information from such past cases. Such flow model that is annotated with information from past cases is referred to as an “annotated flow model.” The IT support manager tool 102 is able to match a flow of activities in the current IT support case with the annotated flow model to recommend the next best step(s).

Although the IT support management system 100 is shown as being a single system, it is noted that the IT support management system 100 can actually represent a distributed management system that includes multiple computers (or other types of devices) that are usable by IT support personnel to address IT support cases. The multiple devices can communicate with each other to perform collaboration.

A “current IT support case” refers to either a newly received IT support case or a previously received IT support case that is to be processed by an IT support organization. The current IT support case may be partially processed (where certain steps of an activity flow have already been taken).

The attributes of a given IT support case (either a current IT support case or a past IT support case 106) can include an attribute relating to the activity flow and attributes relating to the steps of the activity flow taken to process the given IT support case. In addition, an IT support case can also include the following attributes:
Title, which can be chosen for the IT support case by a case submitter (e.g. an end user or other person who submitted the IT support case to the IT support organization);
Tags, which are a set of keywords that are attached to the case by IT support personnel handling the case;
Participant, which can refer to a member of the IT support personnel involved in handling an IT support case, or can refer to the case submitter;
Type, which refers to a particular case type classified from a predefined collection of types allocated by IT support personnel;
Priority, which is a category attribute that specifies the level of severity of the issue represented by the IT support case (the value for this attribute can first be identified by the case submitter and may be changed later by the IT support personnel);
Status, which specifies the status of the case (e.g. drafted, opened, closed, etc.); and
Other text attributes, which include participant comments and a case description, that can be treated as a bag of keywords in analysis relating to the IT support case.

The foregoing attributes of an IT support case are provided for purpose of example. In other examples, additional or alternative attributes can be employed.

As further depicted in FIG. 1, the IT support manager tool 102 includes an annotated model discovery module 110, which is to generate the annotated flow model 104 in accordance with some implementations. The IT support manager tool 102 further includes a steps recommendation module 112, which is able to recommend the next step(s), and possibly even one or multiple experts (which can be IT support personnel), for addressing a current IT support case.

The IT support manager tool 102 is executable on one or multiple processors 114, which is connected to a storage medium 116 (or storage media) that store(s) the annotated flow model 104 and the repository 108 of cases 106. In other implementations, one or both of the annotated flow model 104 and the repository 108 can be stored in a remote storage location.

The IT support management system 100 further includes a network interface 118, which is connected to the processor(s) 114. The network interface 118 allows the IT support management system 100 to communicate with an IT infrastructure 120, which can include various devices as discussed above. Incidents occurring in the IT infrastructure 120 are reported to the IT support management system 100 for processing.

FIG. 2 is a flow diagram of a procedure according to some implementations to address a current case (e.g. a current IT support case). The procedure can be performed by the IT support manager tool 102, for example. The procedure provides (at 202) a flow model of an activity flow that is based on activity flows of past cases (e.g. past IT support cases) that have been processed, where the flow model is annotated with information from the past cases. The procedure next matches (at 204) a current step of an activity flow of the current case to a respective matching step(s) in the flow model, where the matching is based on the annotated information of the flow model.

The procedure then recommends (at 206) at least one next step to take in the current case based on identifying at least one next step that follows the matching step in the flow model. In some implementations, the procedure can also recommend at least one expert, which can include IT support personnel, to handle the current case. The identified expert can be personnel that have been involved in the past in processing similar cases, and has performed the recommended next step at least once.

In examples where multiple next steps are recommended by the procedure of FIG. 2, the multiple next steps can be an ordered collection (or list) of next steps, where the ordering is according to some measure indicating which of the multiple next steps is “better” than another of the next steps. A first next step is “better” than a second next step if a measure of the first next step has some predefined relationship (e.g. greater than, less than, etc.) with respect to a measure of the second next step. More specifically, next steps can be ranked based on techniques discussed in further detail below. The measure for each recommended next step can be computed based on one or multiple factors, which are discussed further below.

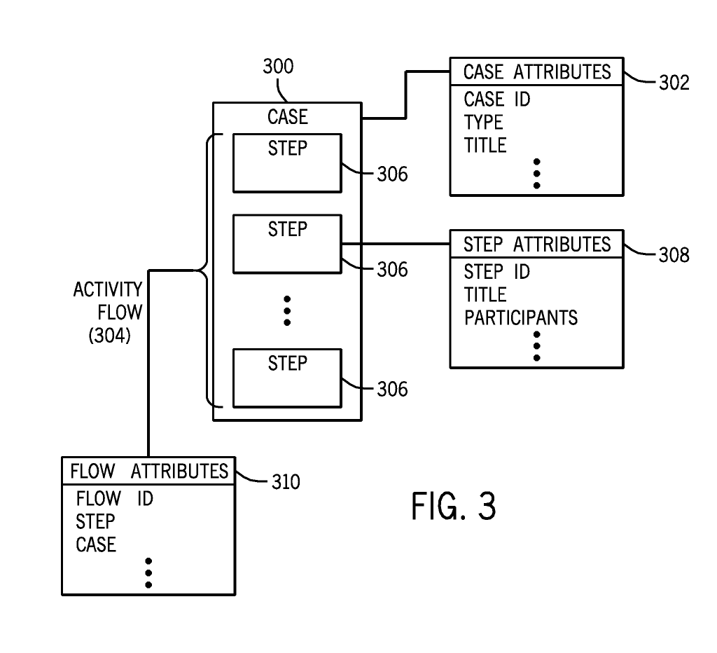

FIG. 3 depicts a model of an IT support case 300, according to some implementations. The IT support case 100 is associated with various case attributes 302. As further shown in FIG. 3, the IT support case 300 includes an activity flow 304, which is made up of a sequence of steps 306. A “sequence of steps” refers to steps that can be taken serially and/or in parallel. Each of the steps is associated with step attributes 308. The activity flow 304 is associated with flow attributes 310.

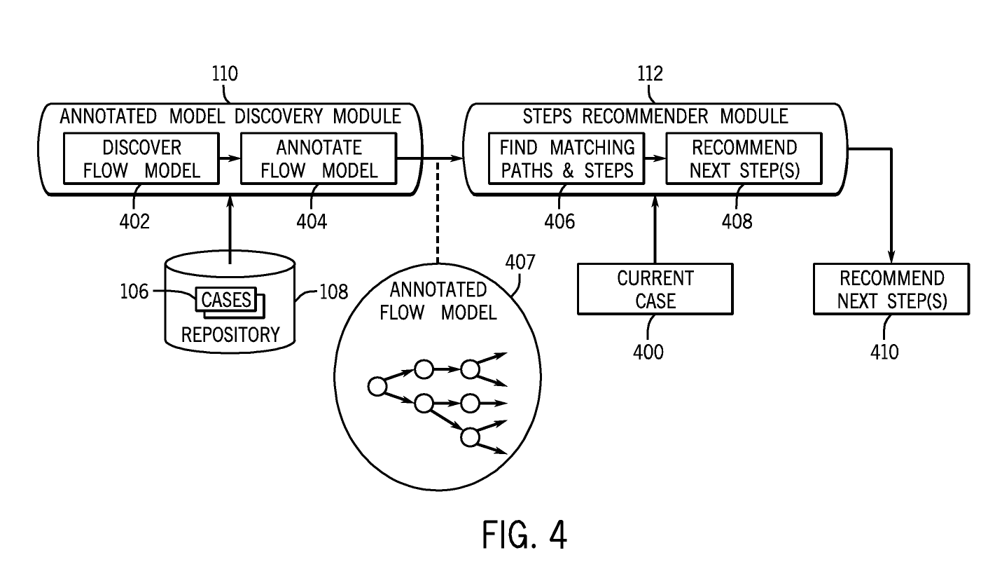

FIG. 4 depicts an example arrangement according to some implementations for recommending a next step to take for a current IT support case 400. The annotated model discovery module 110 discovers (at 402) a flow model based on the past IT support cases 106 in the repository 108. Discovering a flow model refers to learning (generating) the flow model based on information from the cases 106 of the repository 108.

The annotated model discovery module 110 then annotates (at 404) the flow model, which is provided as annotated flow model 407 in FIG. 4. Annotating the flow model 306 involves adding various attributes of a case, an activity flow of the case, and steps of the activity flow. The annotated information is derived from information of the attributes of the cases 106.

The annotated flow model 407 is provided as an input to the steps recommendation module 112. As further shown in FIG. 4, another input to the steps recommendation module 112 is the current case 400 that is to be processed by IT support personnel. The steps recommendation module 112 finds (at 406) a matching step(s) and matching path(s) in the flow model 407 that match a current step (and a path to the current step) of the current case 400 that is being processed.

Note that, in the current case 400, various steps may have already have been taken, such that there is a partial activity flow. The last step of the partial activity flow is referred to as the “current step” of the current case. In some situations, there may be more than one step in the flow model that matches the current step in the current case, based on the similarity between the case information of the current case and the annotated information associated with the steps in the flow model.

Based on finding the matching step(s) and matching path(s) in the annotated flow model 407, the steps recommender module 112 recommends (at 408) the next step(s) 408 to take for the current case 400. The recommended next step(s) 410 can be output to an end user, who may either accept or ignore the recommended next step(s).

In some examples, as noted above, the steps recommender module 112 can also recommend an expert(s) to employ for handling the current case 400. The recommended expert(s) is identified based on the annotated information of the flow model 407, which may contain a participants attribute that identifies personnel who has collaborated to handle the recommended step in the past.

To make a flow model more manageable in terms of size and ease of understanding, a separate flow model can be provided for each case type. There can be multiple case types identified by IT support personnel, such that there would be corresponding flow models. Alternatively, a flow model can represent multiple case types.

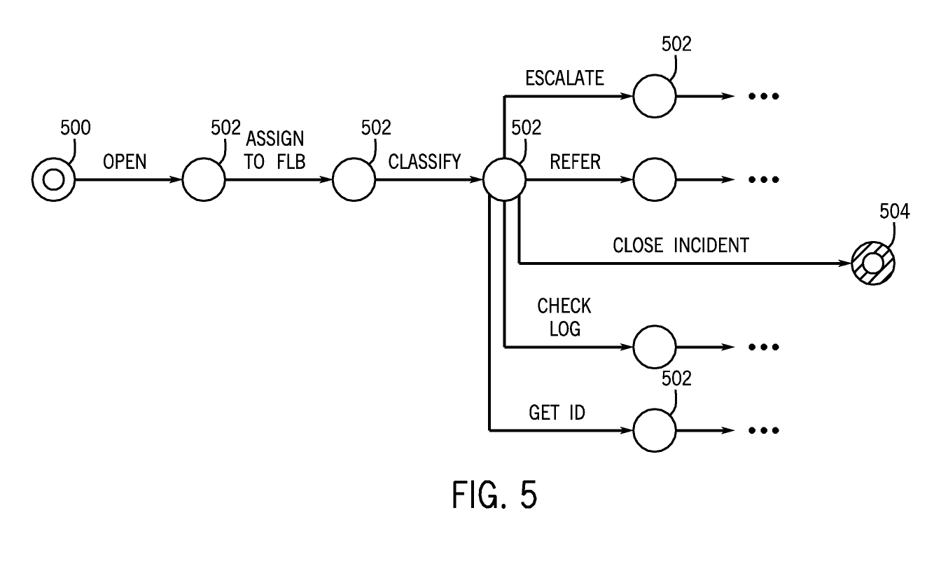

In some examples, flow models are represented by finite state machines (FSMs). In other examples, other representations of flow models can be used. FSMs are easy to understand and visualize, and are suitable for modeling reactive behaviors. An example FSM that represents a flow model of an activity flow is shown in FIG. 5, where the FSM includes a number of nodes (vertices) 500, 502, 504. The FSM also includes transitions between the nodes. The node 500 is a starting node, and represents a starting state. The node 504 is an ending node, and represents an ending state. The nodes 502 are intermediate nodes between the starting node 500 and the ending node 504.

Each transition between the states of the FSM occurs as a result of a respective step taken. Each transition in the flow model is labeled with a step name of the respective step. By traversing the flow model from its start state 500, individual steps of past IT support cases can be reproduced.

In FIG. 5, example step names associated with respective transitions include the following: “Open” (which represents a step for opening a case), “Assign to FLS” (first level support group) (which represents a step for assigning the case to particular IT support personnel), “Classify” (which represents a step to classify the type of case), “Close incident” (which represents a step to close the case), and so forth.

A flow model can thus be represented as an FSM in which each transition (associated with a step) between the nodes of the FSM is annotated with information. The information that annotates a transition can include various types of information, such as those listed below. For example, the information that annotates a transition can include statistical metadata. Examples of statistical metadata include weight and time. “Weight” can refer to a proportional value (expressed as a percentage), computed based on the number of past cases that have taken this particular transition relative to all past cases considered in building the model. In other examples, “weight” can refer to a numeric value that is based on the number of past cases. The “time” metadata can represent an average time relating to execution of a step corresponding to the transition. In other examples, other statistical metadata can be employed, where “statistical” metadata refers to any parameter of attribute that indicates a statistic associated with past cases.

In addition to annotating transitions with statistical metadata, each transition in the flow model can be annotated with information about the conditions (context) under which a transition representing a step is taken in past cases.

The annotated model discovery module 110 of FIG. 1 can further annotate a flow model with further information. For example, the annotated model discovery module 110 can extract information from the following attributes, as examples: case title, tags, priority, description, status, step title, description, participants, etc. The annotated model discovery module 110 then summarizes information of each attribute from the set of cases that include a given step in the model. For category attributes such as priority and case status, all values seen in the past cases and their frequencies can be recorded.

For a text attribute, the annotated model discovery models 110 employs an information retrieval technique to extract keywords that uniquely identify the text attribute by focusing on proper names and domain-specific terms (after removing stop words, which are frequently occurring words). In such approach, besides regular keywords, the annotated model discovery models 110 can extract semantic associations between specific words and identify words as names of companies, people or locations. In IT support cases, names of locations and companies can be useful for unique identification of a step. The set of keywords are kept along with their frequency as part of the step metadata. Additionally, the annotated model discovery module 110 can keep a list of the support personnel who have carried out a step represented by a transition. Such information is used to annotate the transition representing the step. The annotation is in the form of a set of key-value pairs, where the keys are the attributes and the values specify the frequent values (e.g., keywords, category values) observed for the attribute, along with statistical data.

Another type of annotated information in a flow model can include, for each step S, an index that identifies the cases that contain step S in the same order that is observed in the FSM. For instance, in FIG. 5, all the cases that take the “Escalate” step right after “Classify” are identified, and an index of such cases is built for step S.

The following provides further details regarding performing flow model discovery (402 in FIG. 4) from past case information. Flow model discovery can include a hybrid of grammar inference and probabilistic approaches. In some examples, a Markov model can be used to identify step sequences based on statistics about steps that frequently follow each other in the past cases, and to build an FSM from these step sequences. A “step sequence” refers to any sequence of two or more steps within an activity flow. A flow graph representing a step sequence is built as follows: one node is created for each distinct step in any activity flow in the repository 108. For a given order n (Markov order), and for each step sequence of length n+1, uniquely labeled edges connect each step (which is now a vertex) in the sequence to the immediately following step (vertex) in the graph. The resulting graph is converted to an FSM.

The generated FSM may contain equivalent states (nodes) that can be reduced. To reduce these states, the states can be merged, in accordance with some implementations. The following criteria can be applied to find candidate states for merging: i) candidate states with the same outgoing transitions, which include transitions with the same steps to the same target states; ii) candidate states with transitions labeled with the same incoming step name; and iii) candidate states with the same outgoing transitions, excluding any transition that goes to the other state(s) to be merged with a candidate state. After state merging, preexisting transitions between merged states are represented as self-transitions on the newly created state (merged state).

In some implementations, the discovery and annotation (402, 404) of the flow models can be performed offline. Also, the discovery and annotation can be re-iterated to update the flow models. The frequency of updating a flow model is configurable. This approach can incrementally update each flow model, so that the flow model does not have to be rebuilt at each update interval. The annotated model discovery module 110 is also configurable to consider cases within a specified date range, e.g. past 3 days only, past month, etc., such that the annotated model discovery module 110 does not have to consider all cases.

The following provides further details of finding matching paths and steps (406 in FIG. 4). To identify a matching step, the steps recommendation module 112 considers a path leading to a candidate matching step in the flow model, and determines whether such path in the flow model matches a path to the current step in the current case. In some examples, the steps recommendation module 112 can perform approximate sequence matching between the step sequence of the current case and the paths in the flow model where the candidate steps are located. Since the activity flow in the current case is not complete (the activity flow is a partial activity flow), the steps recommendation module 112 considers just paths of the same length or of a length greater than or less than the partial activity flow by some predetermined number (e.g. 3) of steps in the flow model, counting from the start state (500 in FIG. 5) of the FSM. Such considered paths are referred to as candidate paths.

The steps recommendation module 112 first computes the similarity between case information in the current step and annotated information of the steps in the candidate paths, without considering their location in the path. In some examples, the following is a measure of similarity between step i (denoted as Cᵢ) of the current case and step j (denoted as Mⱼ) in the flow model:

StepSimilarity(Cᵢ,Mᵢ)=titleSimilarity*titleCE+tagsSimilarity*tagsCE+descriptionSimilarity* descriptionCE+prioritySimilarity*priorityCE(Eq. 1)

In Eq. 1, titleCE, tagsCE, descriptionCE and priorityCE are coefficients that specify weights of the different respective attributes. In some examples, these coefficients sum to 1. In Eq. 1, the parameter titleSimilarity represents the similarity of the title attribute of the current case step and the flow model step; the parameter tagsSimilarity represents the similarity between tags of the current case step and the flow model step; the parameter descriptionSimilarity represents the similarity between the description of the current case step and the flow model step; and the parameter prioritySimilarity represents the similarity between the priority of the current case step at the flow model step. Although Eq. 1 considers just some of the attributes of the current case step and the flow model step, in other examples, other attributes can also be considered. The priority attribute defines a filter so that steps from cases with at most one (or some other predefined number) priority level difference are considered. For example, if the priority level of a case ranges between 1 and 5, if the priority of the current case is 2, cases with priorities of 1, 2 and 3 are considered, but cases with priorities of 4 and 5 are not considered.

The steps recommendation module 112 chooses the most similar steps in the flow model to that of the current step in the current case (e.g., top 5 steps or some other predefined number of most similar steps). For each of these steps, the next steps recommendation module 112 computes the similarity of the path leading to the step in the flow model with the path leading to the current step in the current case. The flow similarity can be computed as follows:

flowSimilarity(lastStep_{—}Cᵢ,matchingStep_{—}Mⱼ)=StepSimilarity(lastStep_Cᵢ,matchingStep_{—}Mⱼ)+pathSimilarity(1 . . . i, 1 . . . j); (Eq. 2)

in which

$$pathSimilarity ( 1 … i , 1 … j ) = {\sum }_{1 \leq i \leq k} StepSimilarity ( {C}_{l} , {matchingStep\_ M}_{l} ) , \\ k = i - 1 , i \leq j ; k = j - 1 , j \leq i \qquad ( Eq . 3 )$$

In Eq. 2, the StepSimilarity function is computed according to Eq. 1, and the pathSimilarity function is computed according to Eq. 3. Eq. 3 computes the similarity of pair-wise steps in the path immediately before current step, Cᵢ, in the current case and in the path immediate before the matchingStep in the flow model. Eq. 3 considers the position of steps in the paths and whether steps are similar. As a result, when compared to the current step in the current case, the steps in the flow model with a more similar history of actions are ranked higher (due to higher value of pathSimilarity computed according to Eq. 3).

Thus, according to Eqs. 2 and 3, given a set of the top-R (R≧1) steps in the flow according to the step similarity measure of Eq. 1, respective candidate paths to respective ones of the steps in this set are considered. The similarity of each of these candidate paths to the path leading to the current step of the current case is determined according to Eqs. 2 and 3—based on these determined similarities (flowSimilarity or pathSimilarity in Eq. 2 or 3), one of the steps in the set is selected as the matching step to the current step of the current case. The step selected can the one with the highest path similarity measure (flowSimilarity or pathSimilarity).

To perform next step recommendation (408 in FIG. 4), the step recommendations module 112 builds on and extends the approach for finding matching steps in the flow model, discussed above. The step recommendations module 112 finds the next steps immediately after a matching step and ranks the next steps according to their potential match to the context information of the current case, and the likelihood that they lead to a faster resolution based on information from past cases. Note that for recommending next steps in accordance with some implementations, preference can be given to steps that lead to a resolution in a fewer number of steps, as discussed below. In other implementations, preference can be based on other criteria. The next steps recommendation module 112 defines a matching measure of the step Cᵢ (current step of current case) for next steps recommendation as follow:

nextStepMatch(Cᵢ)=flowSimilarity(lastStep_{—}Cᵢ,matchingStep_{—}Mⱼ)+stepCaseMatch (Cᵢ)×resolutionPath(Mⱼ); (Eq. 4)

in which

stepCaseMatch(Cᵢ)=tagsSimilarity*tagsCE+descriptionSimilarity*descriptionCE+prioritySimilarity*priorityCE; (Eq. 5)

and

$$resolutionPath ( {M}_{j} ) = \{ \begin{matrix}1 & resPathLen = 0 \\ Max \{ \begin{matrix}( \begin{matrix}{resPathLen}^{- 1} \times \\ {\sum }_{1 \leq k \leq resPathLen} stepSimilarity ( C , {M}_{k} )\end{matrix} ) , \\ ∀ path ∈ resPath\end{matrix} \} & resPathLen \neq 0\end{matrix} \} \qquad ( Eq . 6 )$$

The parameter resPathLen (which represents a resolution path) in Eq. 6 represents a length of a path (number of steps in the path) for resolving the current case, starting from the current step Cᵢ of the current case. If resPathLen is equal 0 (which means that the resolution path has length 0), then the value of resolutionPath is set to 1. However, if resPathLen is non-zero, then the value of resolutionPath is computed according to the bottom expression in Eq. 6. The resolutionPath function favors a candidate next step with a resolution path of smaller length and higher similarity. The summation of stepSimilarity performed in Eq. 6 for the case where resolutionPath is non-zero computes the sum of the similarities of individual steps in the flow model to the steps of the current case.

The next steps recommendation module 112 then ranks the next steps based on the value of nextStepMatch (Eq. 4), and outputs the ranked collection of next steps to an end user, such as to a user interface to be presented to the user. Along with each next best step, the recommender also can recommend experts, such as IT support personnel who previously carried out the recommended step on similar cases. The list of IT personnel can be sorted, based on the frequency of handling a particular type of case, and the relevance of their profile to the current case.

The various modules described above, such as the IT support manager tool 102, annotated model discovery module 110, and steps recommendation module 112, can be implemented as machine-readable instructions that can be loaded for execution on a processor or multiple processors (e.g. 114 in FIG. 1). A processor can include a microprocessor, microcontroller, processor module or subsystem, programmable integrated circuit, programmable gate array, or another control or computing device.

Data and instructions are stored in respective storage devices, which are implemented as one or more computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
providing, by a system having a processor, a flow model of an activity flow relating to cases that have been processed, wherein the flow model is annotated with information from the cases; and
matching, by the system, a given step of a particular case to a respective matching step in the activity flow of the flow model, wherein the matching is based on the annotated information; and
recommending at least one next step to take in the particular case based on identifying at least one next step from the matching step in the flow model.

2. The method of claim 1, wherein recommending the at least one next step comprises recommending an ordered collection of next steps from the matching step.

3. The method of claim 1, further comprising recommending an expert to process the particular step, wherein the recommended expert is based on information relating to participants in the annotated information.

4. The method of claim 1, wherein providing the flow model comprises learning the flow model based on the cases that have been processed.

5. The method of claim 1, wherein the matching comprises:
identifying candidate paths in the flow model leading to respective candidate steps in the flow model;
determining similarity of a path to the given step in the particular case to each of the identified candidate paths; and
selecting one of the candidate steps as the matching step based on the determined similarities of the candidate paths.

6. The method of claim 5, wherein selecting one of the candidate steps as the matching step comprise selecting the one candidate step that is associated with a corresponding one of the candidate paths that is most similar to the path to the given step in the particular case.

7. The method of claim 1, wherein the given step of the particular case is a current step of a partial activity flow of the particular case.

8. The method of claim 1, wherein recommending the at least one next step comprises selecting one of plural candidate next steps that proceed from the matching step in the flow model, according to a selection criterion that favors a candidate next step having shorter resolution path.

9. The method of claim 1, wherein the annotated information includes statistical metadata associated with transitions between nodes in the flow model.

10. A system comprising:
a storage medium to store a flow model of an activity flow that is based on past cases that have already been processed; and
at least one processor to:
annotate the flow model with information based on attributes of the past cases;
find a matching step in the activity flow that matches a current step of a particular case that is being processed; and
recommend at least one next step based on the matching step in the activity flow of the flow model.

11. The system of claim 10, wherein the past cases include past information technology (IT) support cases, and the particular case is a current IT support case.

12. The system of claim 10, wherein the at least one processor is to find the matching step by considering candidate steps in the activity flow of the flow model, and selecting one of the candidate steps according to at least one predefined criterion.

13. The system of claim 12, wherein the at least one predefined criterion selects one of the candidate steps associated with a path that is most similar to a path leading to the current step of the particular case.

14. The system of claim 10, wherein the at least one processor is to recommend an expert to process the current step, wherein the recommended expert is based on information relating to participants in the annotated information.

15. An article comprising at least one machine-readable storage medium storing instructions that upon execution cause a system to:
access a flow model of an activity flow that is based on past cases that have already been processed, where the flow model is annotated with information based on attributes of the past cases;
find a matching step in the activity flow of the flow model that matches a current step of a particular case that is being processed; and
recommend at least one next step based on the matching step in the activity flow of the flow model.
